(19) United States
(12) Patent Application Publication
(10) Pub. No.: US 2021/0174369 A1
(43) Pub. Date: Jun. 10, 2021

(54) SYSTEM AND METHODS FOR LINKED RESOURCE INTERACTIONS UTILIZING ENHANCED PEER-TO-PEER APPLICATIONS

(71) Applicant: BANK OF AMERICA CORPORATION, Charlotte, NC (US)

(72) Inventors: Christina A. Lillie, Ann Arbor, MI (US); Justin Riley DuPont, Charlotte, NC (US); Malathi Jivan, San Jose, CA (US); Heather Dolan, Sarasota, FL (US); Poppy Marie Kimball, Redwood City, CA (US)

(73) Assignee: BANK OF AMERICA CORPORATION, Charlotte, NC (US)

(21) Appl. No.: 16/704,855

(22) Filed: Dec. 5, 2019

(51) Int. Cl. G06Q 20/40; G06Q 40/02; G06Q 20/22; G06Q 20/36; H04L 29/06

(52) U.S. Cl. CPC G06Q 20/40145; G06Q 40/02; G06Q 20/407; H04L 63/102; G06Q 20/3674; H04L 63/0861; G06Q 20/223

(57) ABSTRACT

Embodiments of the invention are directed to systems, methods, and computer program products for linked resource interactions utilizing enhanced peer-to-peer applications. In particular, the system may continuously collect resource transfer data associated with a user or resource actions conducted using a peer-to-peer payment application, and may assign a unique transaction token identifier to a specific resource action to later identify, reverse, alter, or cancel the specific resource action. In this way, the system may provide an efficient and streamlined way to execute resource actions such as refunds using a single transaction identifier, and enhance the security and integrity of peer-to-peer payment networks by ensuring resource transfers are routed to the appropriate resource accounts.

### FIELD OF THE INVENTION

The present disclosure embraces a system for executing resource transfers and linking subsequent resource transfer activities.

### BACKGROUND

Existing systems and methods for resource transfer on a peer-to-peer basis rely on unidirectional and finite resource transaction activities that provide users and entities with limited options for later alteration or reversal of the transaction activities. There is a need for a more effective way to execute and coordinate resource transfers.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later. Embodiments of the present invention address these and/or other needs by providing a system for linked resource interactions utilizing enhanced peer-to-peer applications. Embodiments of the invention are directed to systems, methods, and computer program products for streamlining the processes involved with the alteration, reversal, and the like of previously completed resource transfers on a peer-to-peer platform. The system is further configured to intelligently authorize and inventory resource interaction data using tokenized security measures that may be fluid and dynamic over time. Furthermore, the system is configured to automate the processes involved with routing resources to appropriate resource accounts during a transaction alteration, reversal, or refund, even in the event of a time-delayed resource action alteration where tokenized security identifiers may have changed for the particular resource interaction being altered.

In some instances, the system comprises: at least one memory device with computer-readable program code stored thereon, at least one communication device, at least one processing device operatively coupled to the at least one memory device and the at least one communication device, wherein executing the computer-readable program code is typically configured to cause the at least one processing device to perform, execute or implement one or more features or steps of the invention.

Embodiments of the invention relate to systems, computer implemented methods, and computer program products for linked resource interactions utilizing enhanced peer-to-peer applications, generally comprising: providing an application on a user device; receiving a request from a user via the user application to initiate a resource action, wherein the resource action comprises sending an amount of resources from a resource account of the user to one or more different resource accounts; requesting authentication information, via the user device, to authenticate the user's identity; receiving authentication information for the user via the user application and verify the user's identity; accessing the user resource account of the user and verify a required resource amount to complete the requested resource action; assigning an identifier value to the requested resource action and log resource action information for the requested resource action using the identifier value; transferring resources from the resource account of the user to a destination resource account to create a completed resource action; receiving a request for reversal or alteration of the completed resource action; accessing the resource action information for the completed resource action using the identifier value; and automating the reversal or alteration of the completed resource action.

In some embodiments, the system is further configured to allow the user to select the destination resource account using a username or alias of a payee.

In other embodiments, the system is further configured to transmit resource action information to the user via the user application after the completed resource action, wherein the resource action information comprises time, date, resource amount, source, and destination of the resource action.

In further embodiments, the authentication information for the user comprises biometric data.

In still further embodiments, automating the reversal of the completed resource action further comprises: locating information for the completed resource action using the resource action identifier; sending a resource amount of the completed resource action from the destination account to the resource account of the user using the same resource action identifier; and aggregating and displaying information for the completed resource action and the reversal of the completed resource action via the user application.

In some embodiments, altering the completed resource action further comprises refunding a portion of the amount of resources using the resource action identifier associated with the completed resource action.

In other embodiments, the reversal or alteration of the completed resource action may be requested by a third party.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts a platform environment 100 providing an enhanced P2P system, in accordance with one embodiment of the present invention;

FIG. 2 depicts a high level process flow diagram 200 for a resource action utilizing the enhanced P2P system, in accordance with one embodiment of the present invention;

FIG. 3 depicts a process flow diagram 300 for a user completing a resource action via the enhanced P2P system, in accordance with one embodiment of the present invention; and

FIG. 4 depicts a process flow diagram 400 for a user completing a resource action alteration or reversal via the enhanced P2P system, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In some embodiments, an “entity” or “enterprise” as used herein may be any institution or establishment, associated with a network connected resource transfer platform, and particularly geolocation systems and devices. As such, the entity may be any institution, group, association, financial institution, merchant, establishment, company, union, authority or the like.

As described herein, a “user” is an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein. In accordance with embodiments of the invention, the term “user” may refer to an authorized person, business or the like, who utilizes an external apparatus such as a user device, for accessing a convers. The external apparatus may be a user device (computing devices, mobile devices, smartphones, wearable devices, and the like). In some embodiments, the user may seek to perform one or more user activities using a web-based application accessed via the user device web browser or in some embodiments may perform one or more user activities using a locally stored application on the user device to interact with the system of the invention. In some embodiments, the user may perform a query by initiating a request for information from the entity systems or various databases using the user device to interface with the system to configure, test, or downgrade system database components.

In the instances where the entity is a resource entity or a merchant, financial institution and the like, a user may be an individual or entity with one or more relationships, affiliations or accounts with the entity (for example, the merchant, the financial institution). In some embodiments, the user may be an entity or financial institution employee (e.g., an underwriter, a project manager, an IT specialist, a manager, an administrator, an internal operations analyst, bank teller or the like) capable of operating the system described herein. In some embodiments, a user may be any individual or entity who has a relationship with a customer of the entity or financial institution.

A “technology resource” or “account” may be the relationship that the user has with the entity. Examples of technology resources include a deposit account, such as a transactional account (e.g. a banking account), a savings account, an investment account, a money market account, a time deposit, a demand deposit, a pre-paid account, a credit account, or the like. The technology resource or account is typically associated with and/or maintained by an entity, and is typically associated with technology infrastructure such that the resource or account may be accessed, modified or acted upon by the user electronically, for example using or transaction terminals, user devices, merchant systems, and the like. In some embodiments, the entity may provide one or more technology instruments or financial instruments to the user for executing resource transfer activities or financial transactions. In some embodiments, an entity may be any institution, group, association, club, establishment, company, union, authority or the like with which a user may have a relationship. As discussed, in some embodiments, the entity represents a vendor or a merchant with whom the user engages in financial (for example, resource transfers like purchases, payments, returns, enrolling in merchant accounts and the like) or non-financial transactions (for resource transfers associated with loyalty programs and the like), either online or in physical stores.

As used herein, a “user interface” may be a graphical user interface that facilitates communication using one or more communication mediums such as tactile communication (such, as communication via a touch screen, keyboard, and the like), audio communication, textual communication and/or video communication (such as, gestures). Typically, a graphical user interface (GUI) of the present invention is a type of interface that allows users to interact with electronic elements/devices such as graphical icons and visual indicators such as secondary notation, as opposed to using only text via the command line. That said, the graphical user interfaces are typically configured for audio, visual and/or textual communication, and are configured to receive input and/or provide output using one or more user device components and/or external auxiliary/peripheral devices such as a display, a speaker, a microphone, a touch screen, a keypad, a mouse, and/or the like. In some embodiments, the graphical user interface may include both graphical elements and text elements. The graphical user interface is configured to be presented on one or more display devices associated with user devices, entity systems, auxiliary user devices, processing systems and the like. In some embodiments, the graphical user interface may be presented in a different configuration depending on the user or type of user that accesses it. In some embodiments, the graphical user interface may be a component of a web-based application that the user may access remotely over a network or a secure virtual private network, secure socket layer, and the like.

Embodiments of the invention are directed to systems, methods, and computer program products for linked resource interactions utilizing enhanced peer-to-peer applications. In particular, the system may continuously collect resource transfer data associated with a user or resource actions conducted using a peer-to-peer payment application, and may assign a unique transaction token identifier to a specific resource action to later identify, reverse, alter, or cancel the specific resource action. In this way, the system may provide an efficient and streamlined way to execute resource actions such as refunds using a single transaction identifier, and enhance the security and integrity of peer-to-peer payment networks by ensuring resource transfers are routed to the appropriate resource accounts.

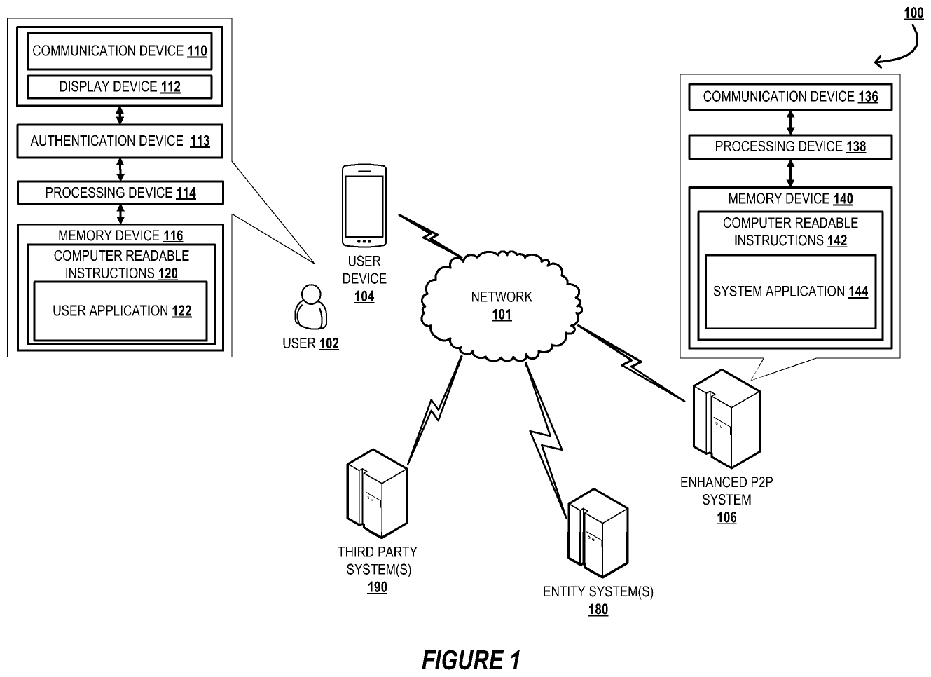

FIG. 1 depicts a platform environment 100 providing a system for linked resource interactions utilizing enhanced peer-to-peer applications. As illustrated in FIG. 1, an enhanced peer-to-peer (P2P) system 106 is configured for providing an application or web application interface accessible by a user 102 via user device 104. The enhanced P2P system 106 is operatively coupled, via a network 101 to one or more user devices 104, to entity systems 180, third party system(s) 190, and other external systems/third-party servers not illustrated herein. In this way, the enhanced P2P system 106 can send information to and receive information from multiple user devices 104 to provide an integrated platform and data access to a user 102. At least a portion of the system is typically configured to reside on the user device 104 (for example, at the user application 122), on the enhanced P2P system 106 (for example, at the system application 144), and/or on other devices and systems such as the entity systems 180 and is a responsive system that facilitates execution of database configurations and version management.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network 101. In some embodiments, the user 102 is an individual that wishes to conduct one or more activities with enhanced P2P system 106 using the user device 104. In some embodiments, the user 102 may access the enhanced P2P system 106, and/or the entity system 180 through a user interface comprising a webpage or a user application. Hereinafter, “user application” is used to refer to an application on the user device 104 of the user 102, a widget, a webpage accessed through a browser, and the like. As such, in some instances, the user device may have multiple user applications stored/installed on the user device 104 and the memory device 116 in particular. In some embodiments, the user application 122 is an application provided by and stored on the user device 104 by the enhanced P2P system 106. In some embodiments the user application 122 may refer to a third party application or a user application stored on a cloud used to access the enhanced P2P system 106 through the network 101. In some embodiments, the user application is stored on the memory device 140 of the enhanced P2P system 106, and the user interface is presented on a display device of the user device 104, while in other embodiments, the user application is stored on the user device 104.

The user 102 may subsequently navigate through the interface, perform one or more resource actions, such as initiate a resource payment or initiate a resource request between an account of the user and another account, configure recurring resource actions, reverse, alter, or refund completed resource actions, and the like, using a central user interface provided by the user application 122 of the user device 104. In some embodiments, the user 102 may be routed to a particular destination such as another application, a security or authentication process of the user device, or a web-site interface using the user device 104. In some embodiments the user device 104 requests and/or receives additional information from the enhanced P2P system 106 or the user device 104 for authenticating the user or the user device, determining appropriate queues, executing information queries, executing scripts, initiating resource action functions, account configuration or preference functions, and other system functions.

The user device 104, herein referring to one or more user devices, wherein each device may generally comprise a communication device 110, a display device 112, a geo-authentication device 113, a processing device 114, and a memory device 116. Typically, the user device 104 is a computing system that allows a user 102 to interact with other systems to initiate or to complete activities, resource transfers, and transactions for products, and the like. The processing device 114 is operatively coupled to the communication device 110 and the memory device 116. The processing device 114 uses the communication device 110 to communicate with the network 101 and other devices on the network 101, such as, but not limited to the entity system 180, datastores 190, and the enhanced P2P system 106. As such, the communication device 110 generally comprises a modem, server, or other device for communicating with other devices on the network 101. In some embodiments, the processing device 114 may be further coupled to the display device 112, the authentication device 113, and/or the transmitter/receiver device, not indicated in FIG. 1. The display device 112 may comprise a screen, a speaker, a vibrating device or other devices configured to provide information to the user. In some embodiments, the display device 112 provides a presentation of the central user interface of the integrated user application 122. The authentication device 113 may comprise biometric scanning devices, discrete memory or processing devices, and other devices configured to securely validate the user 102 and authorize certain resource actions. In some embodiments the user device 104 may include authentication devices like fingerprint scanners, heart-rate monitors, microphones and the like that are configured to receive and analyze bio-metric authentication credentials from the user.

The user device 104 comprises computer-readable instructions 120 stored in the memory device 116, which in one embodiment includes the computer-readable instructions 120 of the user application 122. In this way, users 102 may authenticate themselves, system tools and functions, communicate with the enhanced P2P system 106 to request or transmit information, initiate resource actions, and/or view account data using the central user interface of the user device 104. As discussed previously, the user device 104 may be, for example, a desktop personal computer, a mobile system, such as a cellular phone, smart phone, personal data assistant (PDA), laptop, wearable device, a smart TV, a smart speaker, a home automation hub, augmented/virtual reality devices, or the like. The computer readable instructions 120 such as computer readable/executable code of the user application 122, when executed by the processing device 114 are configured to cause the user device 104 and/or processing device 114 to perform one or more steps described in this disclosure, or to cause other systems/devices to perform one or more steps described herein.

As further illustrated in FIG. 1, the enhanced P2P system 106 generally comprises a communication device 136, at least one processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the entity systems 180, third party systems 190, and/or the user device 104. As such, the communication device 136 generally comprises a modem, server, wireless transmitters or other devices for communicating with devices on the network 101. The memory device 140 typically comprises a non-transitory computer readable storage medium, comprising computer readable/executable instructions/code, such as the computer-readable instructions 142, as described below.

As further illustrated in FIG. 1, the enhanced P2P system 106 comprises computer-readable instructions 142 or computer readable program code 142 stored in the memory device 140, which in one embodiment includes the computer-readable instructions 142 of a system application 144 (also referred to as a “system application” 144). The computer readable instructions 142, when executed by the processing device 138 are configured to cause the system 106/processing device 138 to perform one or more steps described in this disclosure to cause out systems/devices (such as the user device 104, the user application 122, and the like) to perform one or more steps described herein. In some embodiments, the memory device 140 includes a data storage for storing data related to user transactions, resource actions, user accounts, and entity information, but not limited to data created and/or used by the system application 144. In the embodiment illustrated in FIG. 1, and described throughout much of this specification, a “system” configured for performing one or more steps described herein refers to the system application 144 or the interface between the system application 144 and the user application 122, that allows users to perform one or more resource activities either alone or in conjunction with the enhanced P2P system 106, and specifically, the system application 144, and the like.

Further illustrated in FIG. 1 is entity system 180. In some embodiments, the entity system 180 is a financial entity or business that manages the enhanced P2P system 106, and may also store one or more resource accounts for one or more users 102. In this way, the enhanced P2P system may access information from the entity system 180 in order to provide resource account information via the user application 122, and may verify resource account and resource amount information in order to authorize resource actions to or from the one or more resource accounts of the user 102. The resource actions may be conducted through a number of different payment technologies, including, but not limited to, computer-based clearing house and settlement networks (e.g., automated clearing house, or “ACH”), integrated payment information flow networks (e.g. real-time payment, or “RTP”), and the like.

Also shown in FIG. 1 are third party system(s) 190. The third party system 190 may represent other entity systems that maintain user resource account information for one or more users 102. In other embodiments, the third party systems 190 may represent entities other than financial business entities, such as merchants, retailers, businesses, and other users that wish to interface with the enhanced P2P system 106 in order to send or receive resources. In some embodiments, the third party systems 190 may provide information about resource accounts and routing information for one or more users 102 or businesses that the enhanced P2P system 106 may use to direct resources.

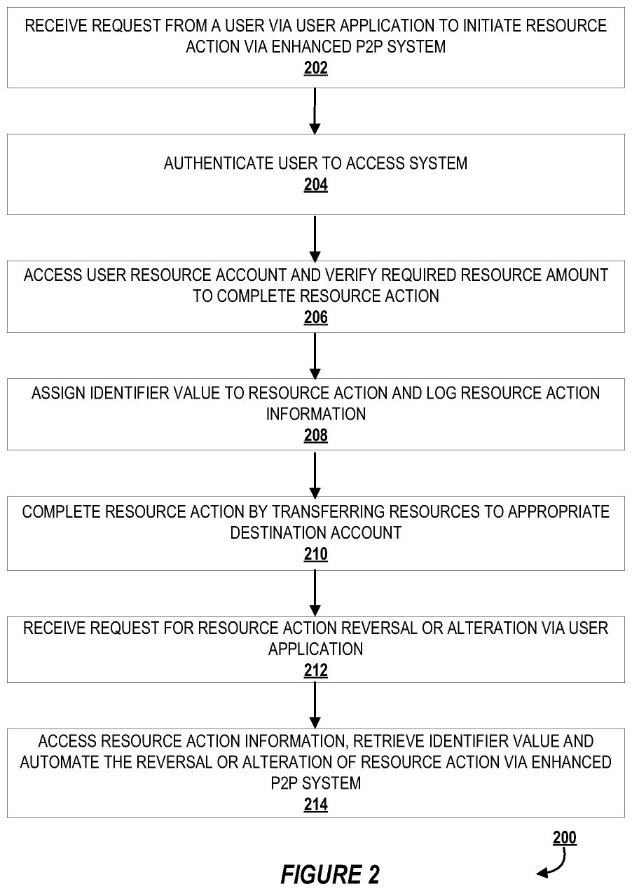

FIG. 2 depicts a high level process flow diagram 200 for a resource action utilizing the enhanced P2P system 106, in accordance with one embodiment of the present invention. As shown, the process begins whereby the system 106 received a request from the user via the user application 122 to initiate a resource action via the enhanced P2P system 106. In some embodiments, the resource action may comprise a payment or a request for payment whereby resources are transferred to or from a user's resource account, which may be stored and managed by entity system 180 or one or more third party systems 190 with which the enhanced P2P system 106 is designed to interact. In this way, the user may navigate the user application in order to initiate a payment of or request for resources via the enhanced P2P system 106. In some embodiments, the user may select a destination or source for the payment or request through a list of contacts or one or more other users enrolled in the enhanced P2P system such that the user does not need to enter specific account information for the destination or source of resources related to the resource action, but rather may just select the identity of one or more users with which to interact during the resource action. In this way, the enhanced P2P system allows the user to easily conduct a payment or request for payment without knowledge of account or routing specifics of the one or more other users. In some embodiments, the user 102 may interact with the user application 122 in order to select a resource account from a list of options provided. The options provided may include a list of resource accounts belonging to the user 102 that are managed by the entity 180, or may be other accounts that the user 102 has provided account information for in order to access the accounts from the user application 122.

In some embodiments, the system 106 may require the user 102 to authenticate their identity before initiating or requesting a resource action be performed, or before accessing the user application 122 or system application 144, as shown in block 204. This authentication step may include use of passcode access, three step authentication, biometric authentication, and the like, and may rely on the authentication device 113 of the user device 104, such that the user is redirected to authenticate themselves via the user device's biometric or passcode authentication process, and then is automatically directed back the user application 122. After the user 102 has been authenticated, the process proceeds to step 206, wherein user resource accounts associated with the user 102 are accessed to verify resource amounts required to complete various resource actions, such as payments or transfers to one or more other users or third parties, such as merchants, businesses and the like.

As shown in block 206, the process proceeds wherein a transaction identifier value is assigned to the resource action and information about the resource action is logged by the enhanced P2P system 106 such as the user account utilized in the resource action, information about the destination account (e.g., user associated with the destination account, destination account number, routing information, managing entity, and the like), and the resource amount associated with the resource action, time, date, and frequency of the resource action, and the like. In some embodiments, descriptive information is also included in the resource action information, such as the purpose for the resource action, goods, services, and the like paid for by the resource action, a message sent along with the resource transfer and the like.

Next, as shown in block 208, the resource action is completed by transferring resources to the appropriate destination account. As discussed previously, the enhanced P2P system 106 may involve the use of any number of payment technologies in order to complete the resource action (e.g., ACH, RTP, and the like). In some embodiments, the enhanced P2P system 106 may transmit a notification to the user 102 via the user application 122 such that the user may view the completed resource action details on a graphical user interface of the user device 104. In some embodiments, the user 102 associated with the destination account may receive a similar notification from the enhanced P2P system 106 summarizing the resource action. In embodiments where the destination user receives a request for payment of resources, the enhanced P2P system 106 may transmit an interactive notification to the destination user wherein the user may interact with the user application 122 on the user device 104 in order to authorize transfer of the requested resource amount. In some embodiments, while authorizing the transfer of the requested resource amount, the user may be presented with the option of choosing a resource account or other payment option (e.g., credit card, debit card, and the like) in order to complete the request, and these details are logged by the enhanced P2P system 106 as further resource action information associated with the same resource action.

As shown in block 210, the process proceeds by completion of the resource action wherein resources are transferred to the appropriate destination account. The completed resource action information is logged as resource action information that the system 106 may later utilize to alter or reverse the resource action, if requested. As shown in block 212, the process may proceed by receiving a request from the user 102 for resource action reversal, partial reversal, alteration, and the like via the user application 122. In this way, the user 102 may select a resource action via the user interface of the user application 122 in order to request that a previously initiated or completed resource action be altered or reversed. It is understood that the system may receive request for resource action alteration or reversal from any user, including the user who originally initiates the resource action, the user associated with the destination of the resource action, and in some cases one or more third party users who may which to re-route, reverse, or otherwise alter the resource action and have the authority to do so. For instance, the user who originally initiated the resource action may realize that the resource action was mistakenly sent to the wrong destination account, and may initiate a request for reversal of the payment of resources. In other embodiments, the user receiving resources may realize that they are not a party to the transaction associated with the resource action, may assume that the resources were transferred to them by mistake, and may initiate a resource action reversal from the destination end of the resource action.

In further embodiments, a third party user or merchant may be entitled to receive resources that were originally directed to another user, such as in instances where a merchant was acquired by another merchant, and the resources may have been routed to an old or outdated account no longer in use. In this case, a third party may request that the resource action be altered such that it is reversed or otherwise re-directed to the correct account. In other embodiments, the subject of the original resource action may have been altered, and thus may require alteration of the resource amount associated with the resource action. For instance, the resource action may have been completed as payment for goods or services, wherein a portion of the goods or services where either cancelled or returned, and require a partial refund to the original payor. In this instance, the resource action may require alteration such that a portion of the resources transferred pursuant to the resource action are returned to the original account, or another account of the payor.

As shown in block 214, after receiving a request for resource action reversal or alteration, the system 106 may access the resource action information, retrieve the identifier value for the resource action, and may use the resource action information in order to automate the reversal or alteration of the resource action. In this way, the system 106 automates the process involved with reversal or alteration of the resource action by allowing one or more users 102 to initiate the reversal or alteration without providing specific account information via the user application 122. This may be advantageous over conventional P2P payment systems or applications for a number of reasons. For instance, in embodiments where resources have been mistakenly transferred to a wrong payee, the payee may identify the mistake and initiate reversal of the resource action without and required knowledge of the originating account information. Furthermore, the reversal of the same resource action alleviates the need to conduct a subsequent resource action or transaction in order to return resources to the originating account, which may alleviate problems associated with the transfer of resources associated with some payment technologies. For instance, using conventional methods, the payee may be required to wait until a transaction completes in order to initiate a new resource action to return the resources mistakenly received, which may involve waiting a number of days after the original resource action is initiated.

In addition, some payment technologies or services may have resource distributions associated with each transaction, which would create additional unnecessary costs associated with returning resources in the event of mistakenly received payments or a requested refund of transferred resources. In such instances, it is advantageous to simply reverse or alter the originals resource action as opposed to creating a new resource action to counter the original transaction. Additionally, the enhanced P2P system 106 may log data associated with the reversal or alteration of the resource action such that a review or audit of resource action is simplified under a single resource action identifier value, whereas in conventional systems it may not be apparent that two resource actions are related if they are identified using separate, unlinked identifiers. In this way, the system 106 may display a resource action history for a single resource action that includes a history of resource action initiation, acceptance, reversal, and alteration in one interface, without the need for the system to consolidate separate resource actions or transactions in order to display this information.

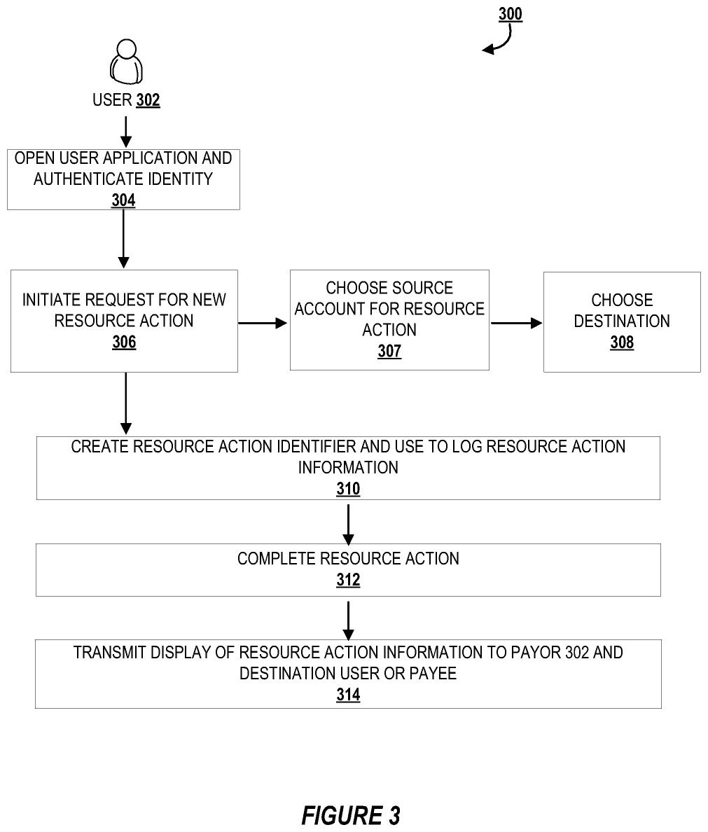

FIG. 3 depicts a process flow diagram 300 for a user 302 initiating a resource action via the enhanced P2P system, in accordance with one embodiment of the present invention. It is understood that the user 302 as described within the embodiment depicted in FIG. 3 is a subset of user 102, wherein the user 302 is specifically initiating a new resource action by utilizing the enhanced P2P system 106. The process flow begins at block 304, wherein the payor 302 opens the user application 122 and authenticates their identity using the various methods and techniques described above which may include entering a passcode, utilizing biometric authentication methods, conducting a three-way authentication via text message or dynamic authentication code, utilizing the authentication hardware associated with the user device 104 and reverting back to the user application 122 and the like.

The payor 302 may then initiate a request for a new resource action as shown at block 306. As part of initiating the resource action, the payor selects a source account to draw resources from for the resource action, as shown in block 307, and chooses a destination, as shown in block 308. It is understood that the destination may be chosen based on descriptive data in the enhanced P2P system 106, such as a name, alias, or merchant identifier, as opposed to a specific account identifier. For instance, in some embodiments, the enhanced P2P system 106 may allow the payor 302 to link a contacts list and the enhanced P2P system will automatically resolve the correct account information that may be stored associated with such contacts, allowing the payor 302 to select a destination for the resource action to send resources based on a contact name or other contact information. In some embodiments, the payor 302 may have been given a unique username or handle associated with a payee, and may manually enter the username or alias for the payee in order to select the payee as the destination for the resource action.

As shown in block 310, the process then continues wherein the system creates a resource action identifier and uses the identifier to log resource action information, such as the resource amount, transfer frequency, scheduling information for the resource action, the source account, the destination account, a description of good or services, and the like. The system then completes the resource action, as shown at block 312, by initiating the transfer of resources from the source account to the destination, and transmits a display of relevant resource action information to the payor 302 and the destination, or payee, via the graphical interface of the user device 104.

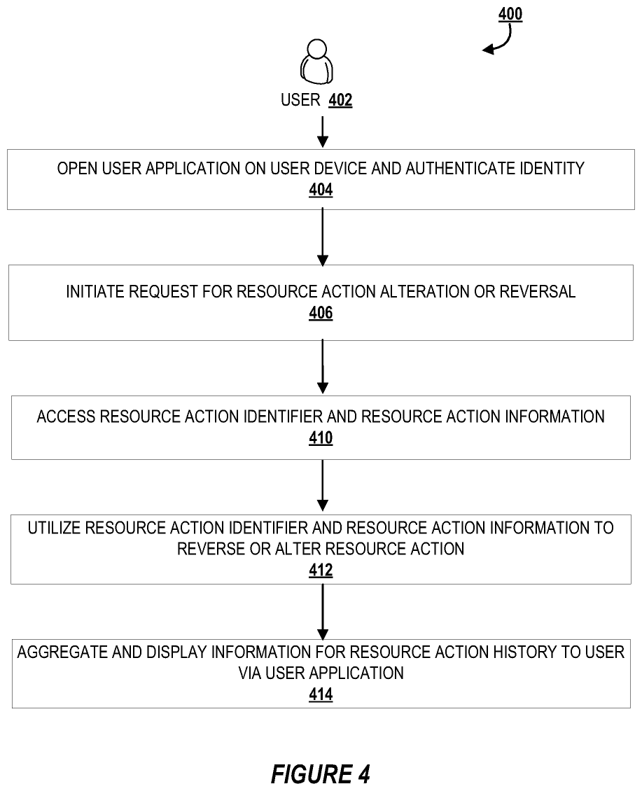

FIG. 4 depicts a process flow diagram 400 for a user 402 completing a resource action alteration or reversal via the enhanced P2P system, in accordance with one embodiment of the present invention. It is understood that the user 402 as described within the embodiment depicted in FIG. 4 is a subset of user 102, wherein the user 402 is initiating the reversal or alteration of a resource action by utilizing the enhanced P2P system 106. The system automates the process of reversing or altering the resource action amount and linking this reversal or alteration with the original resource action, thereby providing the advantages described above with regard to efficiency, simplicity, and lower cost. The process flow begins at block 404, wherein the user 402 opens the user application 122 and authenticates their identity using the various methods and techniques described above which may include entering a passcode, utilizing biometric authentication methods, conducting a three-way authentication via text message or dynamic authentication code, utilizing the authentication hardware associated with the user device 104 and reverting back to the user application 122 and the like.

Next, as shown in block 406, the user 402 may initiate a request for resource action alteration or reversal. For instance, the user 402 may want to reverse a resource action in order to refund the resource amount for a specific transaction. In other embodiments, the user 402 may wish to alter the resource action such that only a partial amount of the total resource amount is refunded. In still further embodiments, the user 402 may wish to change the destination account for the resource action to a different account owned or managed by a different user 102 or a different account that the user 402 owns.

In order to complete the request for resource action alteration or reversal, the system 106 accesses the resource action information associated with the resource action by using the resource action identifier and retrieving the logged data for the resource action, as shown in block 410. The system 106 may then reverse or alter the resource action by either refunding or re-routing a partial or full amount of resources originally associated with the resource action to the user 402′s desired destination, as shown in block 412. The system 106 then logs this information and aggregates and displays the information for the history of the resource action such that it may be displayed via the user application 122, as shown in block 414.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for linked resource interactions utilizing an enhanced peer-to-peer system, the system comprising:
at least one memory device with computer-readable program code stored thereon;
at least one communication device;
at least one processing device operatively coupled to the at least one memory device and the at least one communication device, wherein executing the computer-readable program code is configured to cause the at least one processing device to:
provide a user application on a user device;
receive a request from a user via the user application to initiate a resource action, wherein the resource action comprises sending an amount of resources from a user resource account of the user to one or more different resource accounts;
request authentication information, via the user device, to authenticate the user's identity;
receive authentication information for the user via the user application and verify the user's identity;
access the user resource account of the user and verify a required resource amount to complete the requested resource action;
assign an identifier value to the requested resource action and log resource action information for the requested resource action using the identifier value;
transfer resources from the resource account of the user to a destination resource account to create a completed resource action;
receive a request for reversal or alteration of the completed resource action;
access the resource action information for the completed resource action using the identifier value; and
automate reversal or alteration of the completed resource action.

2. The system of claim 1, wherein the system is further configured to allow the user to select the destination resource account using a username or alias of a payee.

3. The system of claim 1, wherein the system is further configured to transmit resource action information to the user via the user application after the completed resource action, wherein the resource action information comprises time, date, resource amount, source, and destination of the resource action.

4. The system of claim 1, wherein the authentication information for the user comprises biometric data.

5. The system of claim 1, wherein automating the reversal of the completed resource action further comprises:
locating information for the completed resource action using the identifier value;
sending a resource amount of the completed resource action from the destination resource account to the resource account of the user using the identifier value; and
aggregating and displaying information for the completed resource action and the reversal of the completed resource action via the user application.

6. The system of claim 1, wherein altering the completed resource action further comprises refunding a portion of the amount of resources using the identifier value associated with the completed resource action.

7. The system of claim 1, wherein the reversal or alteration of the completed resource action may be requested by a third party.

8. A computer program product for linked resource interactions utilizing an enhanced peer-to-peer system, the computer program product comprising a non-transitory computer-readable storage medium having computer-executable instructions to:
provide a user application on a user device;
receive a request from a user via the user application to initiate a resource action, wherein the resource action comprises sending an amount of resources from a user resource account of the user to one or more different resource accounts;
request authentication information, via the user device, to authenticate the user's identity;
receive authentication information for the user via the user application and verify the user's identity;
access the user resource account of the user and verify a required resource amount to complete the requested resource action;
assign an identifier value to the requested resource action and log resource action information for the requested resource action using the identifier value;
transfer resources from the resource account of the user to a destination resource account to create a completed resource action;
receive a request for reversal or alteration of the completed resource action;
access the resource action information for the completed resource action using the identifier value; and
automate reversal or alteration of the completed resource action.

9. The computer program product of claim 8, further configured to allow the user to select the destination resource account using a username or alias of a payee.

10. The computer program product of claim 8, further configured to transmit resource action information to the user via the user application after the completed resource action, wherein the resource action information comprises time, date, resource amount, source, and destination of the resource action.

11. The computer program product of claim 8, wherein the authentication information for the user comprises biometric data.

12. The computer program product of claim 8, wherein automating the reversal of the completed resource action further comprises:
locating information for the completed resource action using the identifier value;
sending a resource amount of the completed resource action from the destination resource account to the resource account of the user using the identifier value; and
aggregating and displaying information for the completed resource action and the reversal of the completed resource action via the user application.

13. The computer program product of claim 8, wherein altering the completed resource action further comprises refunding a portion of the amount of resources using the identifier value associated with the completed resource action.

14. The computer program product of claim 8, wherein the reversal or alteration of the completed resource action may be requested by a third party.

15. A computer implemented method for linked resource interactions utilizing an enhanced peer-to-peer system, the computer implemented method comprising:
providing a user application on a user device;
receiving a request from a user via the user application to initiate a resource action, wherein the resource action comprises sending an amount of resources from a user resource account of the user to one or more different resource accounts;
requesting authentication information, via the user device, to authenticate the user's identity;
receiving authentication information for the user via the user application and verify the user's identity;
accessing the user resource account of the user and verify a required resource amount to complete the requested resource action;
assigning an identifier value to the requested resource action and log resource action information for the requested resource action using the identifier value;
transferring resources from the resource account of the user to a destination resource account to create a completed resource action;
receiving a request for reversal or alteration of the completed resource action;
accessing the resource action information for the completed resource action using the identifier value; and
automating reversal or alteration of the completed resource action.

16. The computer implemented method of claim 15, further configured to allow the user to select the destination resource account using a username or alias of a payee.

17. The computer implemented method of claim 15, further configured to transmit resource action information to the user via the user application after the completed resource action, wherein the resource action information comprises time, date, resource amount, source, and destination of the resource action.

18. The computer implemented method of claim 15, wherein automating the reversal of the completed resource action further comprises:
locating information for the completed resource action using the identifier value;
sending a resource amount of the completed resource action from the destination resource account to the resource account of the user using the identifier value; and
aggregating and displaying information for the completed resource action and the reversal of the completed resource action via the user application.

19. The computer implemented method of claim 15, wherein altering the completed resource action further comprises refunding a portion of the amount of resources using the identifier value associated with the completed resource action.

20. The computer implemented method of claim 15, wherein the reversal or alteration of the completed resource action may be requested by a third party.
